(19) United States
(12) Patent Application Publication
(10) Pub. No.: US 2009/0087898 A1
(43) Pub. Date: Apr. 2, 2009

(54) Methods, processes and apparatus of sequestering and environmentally coverting oxide(s) of carbon and nitrogen

(75) Inventors: Richard Alan Haase, Missouri City, TX (US); Candice Marie Haase, Missouri City, TX (US)

Correspondence Address: RICHARD A. HAASE (INVENTOR), 4402 RINGROSE DRIVE, MISSOURI CITY, TX, 77459, US

(73) Assignee: ClearValue, Inc.

(21) Appl. No.: 12/231,992

(22) Filed: Sep. 8, 2008

Related U.S. Application Data
(60) Provisional application No. 60/967,742, filed on Sep. 6, 2007.
(60) Provisional application No. 61/011,403, filed on Jan. 17, 2008.
(60) Provisional application No. 61/130,706, filed on Jun. 2, 2008.

(51) Int. Cl. A62D 3/02; B01D 53/62; B01D 53/56

(52) U.S. Cl. 435/262.5; 423/235; 423/225

(57) ABSTRACT

The instant invention presents improved means for sequestering CO_{X} and/or NO_{X} in the aqueous phase of a gas scrubber. The instant invention presents means for the scrubbing of CO_{X} and/or NO_{X} gas by chemically assimilating at least one of CO_{X} and NO_{X}. The instant invention presents means for concentrating the CO_{X} and/or the NO_{X} in the aqueous phase by creating a metal salt comprising the CO_{X} and/or the NO_{X}. To control salt deposition, the instant invention presents means of chemical dispersion so that salt deposition can be controlled and the aqueous phase can become an efficient and effective carrier of the CO_{X} and/or the NO_{X}. Means of controlling sulfide and sulfate emissions are presented incorporating sulfur consuming bacteria.

### RELATED APPLICATION DATA

This application claims priority on U.S. Provisional Application 60/967,742 filed Sep. 06, 2007; U.S. Provisional Application 61/011,403 filed Jan. 17, 2008; and U.S. Provisional Application 61/130,706 filed Jun. 2, 2008.

### BACKGROUND OF THE INVENTION

### Field of the Invention

The instant invention relates to improved means (herein means refers to methods, processes and apparatus) for the sequestering of oxides of carbon and oxides of nitrogen. The instant invention improved means for the scrubbing of oxides of carbon and oxides of nitrogen is herein defined as the Hydrocarbon combustion Aqueous Assimilation System for the Environment (HAASE). HAASE chemically assimilates at least one of: oxide(s) of carbon (CO and CO₂, herein after referred to as CO_{X}), and oxide(s) of nitrogen (N_{Y}O_{X}, which can be N₂O, NO, NO₂ or NO₃ and are herein after referred to as NO_{X}) from a hydrocarbon combustion gas. Within the instant invention, Gas Flow is defined as a source and/or flow of gas comprising CO_{X} and/or NO_{X}.

The instant invention (HAASE) relates to a means for minimizing CO_{X} and/or NO_{X} emissions. The instant invention (HAASE) relates to reducing and/or minimizing CO_{X} and/or NO_{X} emissions emanating from the burning of fossil fuels or extracting natural gas or of converting a hydrocarbon into hydrogen (H₂).

There is currently a great interest in reducing emissions of CO_{X} and of NO_{X} gases into the atmosphere. The amount of CO_{X} emitted into the air is cited as a factor contributing to global warming. CO_{X} is emitted whenever fossil fuels are burned and NO_{X} is emitted when ever fossil fuels are burned in air or with nitrogen (N₂) present, such as in automobile engines and coal burning furnaces, such as those used by power plants. Reducing CO_{X} and NO_{X} emissions is of increased importance and is a point of specific emphasis for government regulatory agencies. This is especially so for power plants burning large volumes of fossil fuels, emitting large quantities of COₓ and NOₓ into the atmosphere.

### BACKGROUND OF THE INVENTION

Mankind has, over the centuries, developed many forms of energy, along with many forms of transportation. In the modern economy, energy is needed to literally “fuel” the economy. Energy heats homes, factories and offices; provides electrical power; powers manufacturing facilities, and provides for the transportation of goods and people.

During the 19'th and 20'th centuries, mankind developed fossil, hydrocarbon, fuels into reliable and inexpensive energy sources. This use has caused the combustion products from fossil fuels to be a major source of air and water (H₂O) pollution.

Fossil fuels (hydrocarbons) are used as a fuel along with air as an oxidant to generate combustion energy. Hydrocarbons, C_{X}H_{Y}, are most often either: petroleum distillates such as gasoline, diesel, fuel oil, jet fuel and kerosene; or, fermentation distillates such as methanol and ethanol; or, natural products such as methane, ethane, propane, butane, coal and wood. The products of hydrocarbon combustion were thought to work in concert with nature's O₂-carbon cycle, wherein CO₂ is recycled by plant life photosynthesis back into O₂. However, excess hydrocarbon combustion interferes with nature; excess CO_{X}, e.g. excess combustion, upsets the environment causing global warming. The combustion of a hydrocarbon can be approximated by:

CₙH₂ₙ₊₂+(3/2n+½)O₂→nCO₂+(n+1)H₂O+Energy

More specifically, for gasoline (2, 2, 4 trimethyl pentane or Octane):

gasoline (Octane)+12½O₂→8CO₂+9H₂O+1,300 kcal

And, for natural gas (methane):

CH₄+3/2O₂→CO₂+2H₂O+213 kcal

So, COx is produced by the combustion of fossil fuels, while it is generally believed that global warming is a result of a buildup of CO_{X} in the Earth's atmosphere. And, while photosynthesis will naturally turn CO₂ back into O₂, man-made production of CO₂ in combination with significant deforestation have left Earth's plant life incapable of converting enough of manmade CO₂ back into O₂. This is while CO, an incomplete combustion by-product, is toxic to all human, animal and plant life.

In addition, hydrocarbon combustion with air creates NO_{X}; NO_{X} retards photosynthesis while being toxic to all human, animal and plant life. Once formed, NO_{X} further reacts with O₂ in the air to form ozone (O₃). O₃ is toxic to all human, animal and plant life. O₃ does protect the earth in the upper atmosphere from harmful ultraviolet (UV) radiation; however, at the surface O₃ is toxic. Therefore, the production of NO_{X} further interferes with the capability of earth's plant life to convert enough of manmade CO₂ back into O₂.

Lastly, CO_{X} and NO_{X} react with H₂O in the air and on the surface of the earth to form acids, e.g. H₂CO₃, HNO₂ and H₂NO₃, which in the air, then, literally rain acids upon the earth.

Hydrocarbon fuels have been modified with additives to minimize the formation of COx or NOx. However, with all of the engine modifications and fuel modifications, the Earth has become unable to keep up.

It is well known in general chemistry to react CO_{X} with an aqueous solution comprising at least one of: sodium hydroxide (NaOH), potassium hydroxide (KOH), calcium hydroxide (Ca(OH)₂), and magnesium hydroxide (Mg (OH)₂), and any combination therein to form a solid precipitate of carbonate (CO₃²⁻) or of bi-carbonate (HCO₃⁻) with the corresponding metal cation to form a solid precipitate. However, these means suffer from either the use of a hazardous chemical, e.g. NaOH or KOH, or a chemical which is difficult to keep soluble, e.g. Ca(OH)₂ or Mg(OH)₂, and which may affect throughput. Processes for the adsorption of CO₂ with a group IA and IIA metal hydroxide are disclosed and presented in U.S. Pat. No. 4,407,723, while used as a reference in this instant invention.

It is also well known in general chemistry to react NOx in water to form nitrite (NO₂²⁻) or nitrate (NO₃²⁻) and then react the (NO₂²⁻) or (NO₃²⁻) with ammonia (NH₃) or aqueous ammonium NH₄OH) to form ammonium nitrate ((NH₄)₂NO₃); however, (NH₄)₂NO₃ is also a hazardous chemical, especially when exposed to a hydrocarbon or fossil fuel.

Currently, systems for controlling and eliminating CO₂ from a breathable air supply are utilized in submarines, space vehicles and space suits. These systems utilize a CO₂ sorbent bed composed of a plurality of amine sorbent beads disposed within a container. A stream of air containing CO₂ is flowed through the container and the amine sorbent beads. The CO₂ contacting the amine sorbent beads react therewith to become trapped within the container. The remainder of the breathable air recirculates into the controlled environment Once the container has become saturated with CO₂ such that further absorption of CO₂ is inefficient, the breathable air stream is switched to a second container. The saturated container is then exposed to heat or reduced pressure to evolve or release the trapped CO₂ for disposal or use in other systems. Such systems have proven effective and efficient for controlling the CO₂ content within an enclosed environment; however, this technology and related technologies still must release CO₂ to the atmosphere. Processes for the adsorption of CO₂ are disclosed and presented in U.S. Pat Nos.2,545,194; 3,491,031; 3,594,983; 3,738,084; 4,005,708; 4,539,189; 4,668,255; 4,674,309; 4,810,266; 4,822,383; 4,999,175; 5,281,254; 5,376,614; 5,462,908; 5,492,683; 5,518,626; 5,876,488; 6,274,108; 6,355,094; 6,364,928; 6,547,854; 6,755,892 and U.S. Publication 2002/0083833, while used as a reference in this instant invention.

Previous work in the scrubbing of hydrocarbon combustion gases focused on the removal of oxides of sulfur (SO_{X}) by reaction of SO_{X} with an alkaline earth metal in order to form a calcium sulfate. Processes for the adsorption of SO_{X} are disclosed and presented in U.S. Pat. Nos. 4,233,175 and 7,247,285, while used as a reference in this instant invention.

Current work in the use of algae to convert COx and NOx into oxygen (O₂) and algae is showing promise; however, in all situations for this technology, the COx and/or NOx must be transported to a rather significant greenhouse-type algae unit For transportation applications, algae technology is impractical due to the required storage of large quantities water. For power generation applications this technology requires a rather large greenhouse-type algae unit, along with the movement of very large quantities of water. In all cases, algae technology requires the availability of sunlight, wherein many parts of the earth do not have enough continuous sunlight available. Therefore, even for these promising means there is a need of a means of COx and NOx capture (sequester) and storage, as well as transfer.

Current catalyst work to convert NOx to N₂ comprises reacting the NOx with platinum and rhodium catalyst. This type of catalysis is commonly used in the three-way catalytic converters in transportation applications.

Current work to transport and/or store CO_{X} comprises compression of the CO_{X} gas, as well as the underground compression and eventual liquefaction of the CO_{X} gas. This underground storage and/or liquefaction presents many costs and risks; as, there is a significant energy requirement to compress and transfer the CO_{X} gas and there is a risk that underground storage of the CO_{X} gas may leak to the Earth's Surface.

Water Dispersion Chemistry—The instant invention relates to methods of controlling CO_{X} and NOx scale and deposition in water applications. U.S. Pat No. 4,209,398 issued to Ii, et al., on Jun. 24, 1980, while used as a reference in this instant invention, presents a process for treating water to inhibit formation of scale and deposits on surfaces in contact with the water and to minimize corrosion of the surfaces. The process comprises mixing in the water an effective amount of water soluble polymer containing a structural unit that is derived from a monomer having an ethylenically unsaturated bond and having one or more carboxyl radicals, at least a part of said carboxyl radicals being modified, and one or more corrosion inhibitor compounds selected from the group consisting of inorganic phosphoric acids and water soluble salts thereof, phosphonic acids and water soluble salts thereof, organic phosphoric acids and water soluble salts thereof, organic phosphoric acid esters and water-soluble salts thereof and polyvalent metal salts, capable of being dissociated to polyvalent metal ions in water. The Ii patent does not discuss or present systems of COx and/or NOx sequestration.

U.S. Pat. No. 4,442,009 issued to O'Leary, et al., on Apr. 10, 1984, while used as a reference in this instant invention, presents a method for controlling scale formed from water soluble calcium, magnesium and iron impurities contained in boiler water. The method comprises adding to the water a chelant and water soluble salts thereof, a water soluble phosphate salt and a water soluble poly methacrylic acid or water soluble salt thereof. The O'Leary patent does not discuss or present systems of COx and/or NOx sequestration.

U.S. Pat. No. 4,631,131 issued to Cuisia, et al., on Dec. 23, 1986, while used as a reference in this instant invention, presents a method for inhibiting formation of scale in an aqueous steam generating boiler system. Said method comprises a chemical treatment consisting essentially of adding to the water in the boiler system scale-inhibiting amounts of a composition comprising a copolymer of maleic acid and alkyl sulfonic acid or a water soluble salt thereof, hydroxylethylidene, 1-diphosphic acid or a water soluble salt thereof and a water soluble sodium phosphate hardness precipitating agent. The Cuisia patent does not discuss or present systems of COx and/or NOx sequestration.

U.S. Pat. No. 4,640,793 issued to Persinski, et al., on Feb. 3, 1987, while used as a reference in this instant invention, presents an admixture, and its use in inhibiting scale and corrosion in aqueous systems, comprising (a) a water soluble polymer having a weight average molecular weight of less than 25,000 comprising an unsaturated carboxylic acid and an unsaturated sulfonic acid, or their salts, having a ratio of 1:20 to 20:1, and (b) at least one compound selected from the group consisting of water soluble polycarboxylates, phosphonates, phosphates, polyphosphates, metal salts and sulfonates. The Persinski patent presents chemical combinations which prevent scale and corrosion; however, the Persinski patent does not discuss or present systems of COx and/or NOx sequestration.

Sulfur Consuming Bacteria—In recent years, there have been identified many strains of bacteria (or bacterium) which metabolize or consume sulfur in their biomass. Most of these strains of bacteria are obligate aerobes capable of taking oxygen, SO₂, SO₃, NO₃, and NO₃ as an electron donor source for the conversion of H₂S to S. Most of these strains have difficulty or react slowly to convert SO₄ to S. Many of these strains of bacteria are capable of operating in an aerobic environment. For the aerobic strains, unfortunately, in an aerobic environment, a portion of the sulfides are converted to sulfate, which converts to sulfuric acid. Therefore, the facultative or anoxic strains are preferred in the conversion of sulfides to S so as to minimize the formation of sulfate.

Strains of bacteria known for their conversion of sulfides to elemental sulfur in their biomass include but are not limited to: strains of the genus Thiobacillus with the strain Thiobacillus denitrificans most known and as presented in U.S. Pat No. 6,126,193 and U.S. Pat No. 5,705,072, both of which are referenced to the instant invention; gram-negative bacteria from the beta or gamma subgroup of Proteobacteria, obligate autotrophs, Thioalkalovibrio, strain LMD 96.55, Thioalkalobacter, alkaliphilic heterotrophic bacteria, and Pseudomonas strain ChG 3, all of which as described in U.S. Pat No. 6,156,205, while used as a reference in this instant invention. Further strains are described in U.S. Pat No. 7,101,410, while used as a reference in this instant invention, lists: Rhodococcus erythropolis, Rhodococcus rhodochrous, other Rhodococcus species (sp.), Nocardia erytiropolis, Nocardia corrolina, other Nocardia species Pseudomonas putida, Pseudomonas oleovorans, other Pseudornonas sp., Arthrobacter globiformis, Arthobacter Nocardia paraffinae, Arthrobacter paraffineus, Artirobacter citreus, Artirobacter luteus, other Arthrobacter sp., Mycobacterium vaccae JOB and other Mycobacterium Acinetobacter sp. (rag) and other sp. of Acinetobacter, Corynebacterium sp. and other Corynebacterium sp., Thiobacillus ferrooxidans, Thiobacillus intermedia, other sp. of Thiobaillus Shewanella sp., Micrococcus cinneabareus, other micrococcus sp., Bacillus sulfasportare and other bacillus sp. Fungi, White wood rot fungi, Phanerochaete chrysosporium Phanerochaete sordida, Trametes trogii, Tyromyces palustris, other white wood rot fungal sp. Streptomyces fradiae, Streptomyces globisporus, and other Streptomyces sp., Saccharomyces cerrevisiae, Candida sp., Cryptococcus albidus and other yeasts Algae.

Denitrifying Bacteria—It has heretofore been well known that existence of nitrogen compounds is one cause of river and lake eutrophication. In the biological treatment of water, ammonia nitrogen contained in for-treatment water is converted into NO₃²⁻. Then the NO₃²⁻ can be reduced to N₂ gas by denitrifying bacteria. This reduction is brought about by certain bacteria which are able, in the absence of O₂, to utilize NO₃²⁻ and NO₂²⁻ in place of O₂ to oxidize available and microbially utilizable organic compounds. In the chemical reaction characterized by this microbial process, NO₃²⁻ and NO₂²⁻ serve as terminal electron donors and the assimilable or microbially utilizable carbon compounds serve as electron acceptors. Since the purpose of microbial denitrification is to eliminate all oxidized nitrogen compounds, it is essential that there be available an excess of the carbon/energy source to insure that denitrification goes to its theoretical completion and that there be sufficient additional carbon available for bacterial growth. The amount of carbon required can be readily calculated stoichiometrically and where methanol is the carbon source, 3 mg/l of methanol will adequately reduce 1 mg/l of NO₃²⁻ and provide sufficient carbon for bacterial growth.

Carbon source supplementation is essential to compensate for carbon and BOD deficiencies in both the digested nitrocellulose waste and the domestic sewage. Denitrification can be carried out in a conventional tank of suitable size using activated sludge as a source of suitable denitrifying bacteria or relying on the bacteria normally present in raw sewage and holding the mixed liquor under essentially anaerobic conditions. The time required for denitrification will depend on the concentration of NO₃²⁻ and NO₂²⁻, the temperature of the liquor within the tank, the dissolved oxygen content, the population of denitrifying bacteria and the concentration of available microbially utilizable carbon material. None of the foregoing conditions is critical except that the dissolved O₂ concentration must be below that normally required for aerobic microbial growth and the temperature of the liquor should not drop below that at which the bacteria can efficiently denitrify the NO₃²⁻ and NO₂²⁻. Many common facultative bacteria are able to effect denitrification, including members of the genera Pseudomonas, Bacillus, and Achromobacter, as well as the facultative strains of Thiobacillus, such as Thiobacillus denitrificans. Suitable denitrifying bacteria will be present in most activated sludge mass material or raw sewage material. After denitrification is completed, solids in the liquor are allowed to settle either in the same vessel or in a separate sedimentation vessel. Following sedimentation, the dear effluent is removed and the solids remaining are recycled for further denitrification. While these microbial processes are well known, there is no currently means of employing these methods in the conversion of NOx gas.

In summary, COx, NOx and O₃ are direct, indirect and resultant products, respectively, of the combustion of hydrocarbons. These products adversely affect: all life, our environment and health of our Earth. The instant invention has proven an environmentally acceptable method, process or apparatus to significantly reduce the concentration of COx and/or NOx, especially from hydrocarbon combustion while creating a salt which works in concert with and occurs regularly in nature. This is while there is a significant and here-to-fore unmet and long felt need of humanity to sequester and preferably convert COx and/or NOx gases.

### SUMMARY OF THE INVENTION

A primary object of the instant invention is to devise environmentally friendly, effective, efficient and economically feasible methods, processes and apparatus, wherein COx is sequestered.

Another object of the instant invention is to devise environmentally friendly, effective, efficient and economically feasible methods, processes and apparatus, wherein COx and/or NOx from the combustion of a hydrocarbon is effectively and efficiently removed from a combustion exhaust.

Another object of the instant invention is to devise environmentally friendly, effective, efficient and economically feasible methods, processes and apparatus, wherein COx and/or NOx from the combustion of a hydrocarbon is effectively and efficiently converted into a harmless salt.

Further, an object also of the instant invention is to devise environmentally friendly, effective, efficient and economically feasible methods, processes and apparatus, wherein COx and/or NOx from the combustion of a hydrocarbon is effectively and efficiently converted into a harmless salt which can be easily disposed.

Still further, an object of the instant invention is to devise environmentally friendly, effective, efficient and economically feasible methods, processes and apparatus, wherein COx and/or NOx from the combustion of a hydrocarbon is effectively and efficiently converted into a salt which has use as a soil stabilizer.

Still further yet, an object of the instant invention is to devise environmentally friendly, effective, efficient and economically feasible methods, processes and apparatus, wherein COx and/or NOx from the combustion of a hydrocarbon are effectively and efficiently converted into a salt which has use as a building material.

Still further yet, an object of the instant invention is to devise environmentally friendly, effective, efficient and economically feasible methods, processes and apparatus, wherein COx and/or NOx from the combustion of a hydrocarbon are effectively and efficiently converted into a salt which has use as a buffer of pH.

Still also further yet also, an object of the instant invention is to devise environmentally friendly, effective, efficient and economically feasible methods, processes and apparatus, wherein COx and/or NOx from the combustion of a hydrocarbon are effectively and efficiently converted into a salt which can be reacted with an acid to release CO₂ and/or NO₂.

Further yet still, an object of the instant invention is to devise environmentally friendly, effective, efficient and economically feasible methods, processes and apparatus, wherein COx is converted into plant matter and O₂.

Further yet still also, an object of the instant invention is to devise environmentally friendly, effective, efficient and economically feasible methods, processes and apparatus, wherein NOx from the combustion of a hydrocarbon is effectively and efficiently converted into N₂.

Additional objects and advantages of the instant invention will be set forth in part in a description which follows and in part will be obvious from the description, or may be learned by practice of the invention.

HAASE embodies incorporating CO_{X} and NO_{X} into an aqueous phase. HAASE embodies the water adsorption characteristics of CO_{X} and/or NO_{X}. HAASE further embodies combining at least one of CO_{X} and NO_{X} into metal salt(s), preferably into a Group IA or Group IIA metal salt, most preferably into a salt comprising at least one of sodium, magnesium or calcium. HAASE further also embodies the affinity that a metal, preferably a Group IA metal or Group IIA metal, and most preferably at least one of sodium, magnesium or calcium, has for carbonate anions. HAASE also further embodies the insolubility characteristics of a metal, preferably a Group IA IIA metal, most preferably at least one of sodium or calcium with carbonate, whether as a hydrate or in an anhydrous form. HAASE further still embodies the anti-agglomeration characteristics of a dispersant in combination with a metal-CO₃ or a metal-NO₂ or a metal-NO₃ in aqueous solution.

The instant invention has surprisingly been discovered to inexpensively and safely remove at least one of CO_{X} and/or NO_{X} from a gas. In a most preferred embodiment, at least a portion of the CO_{X} and/or NO_{X} are adsorbed into an aqueous phase, wherein at least a portion of the CO_{X} and/or NO_{X} is reacted with a metal salt. It is preferred that the metal salt be added to the aqueous phase as at least one selected from the group consisting of: calcium sulfate, calcium sulfate ½ hydrate, calcium sulfate hydrate, calcium sulfate di-hydrate, and any combination therein.

This instant invention is surprisingly found to be easily configured in a variety of process and equipment arrangements such that the instant invention can be easily added to any source of CO_{X} and/or NO_{X}. The instant invention is surprisingly found to be practically added to modes of transportation, e.g. a motorcycle, an automobile, a truck, a boat, or etc. The instant invention has surprisingly been found to practically be added to the exhaust stack of a power plant, a manufacturing plant, a furnace or any type of combustion method, process or device. The instant invention has surprisingly been found to be economically practical in application and in use, wherein economics and practicality are important characteristics of an invention such as the instant invention which has to have broad appeal in order to be implemented. Finally, the instant invention has surprisingly been found to be an economical and practical means to store CO_{X} and/or NO_{X} be that above or below ground.

### BRIEF DESCRIPTION OF THE DRAWINGS

A better understanding of the instant invention can be obtained when the following descriptions of the preferred embodiments are considered in conjunction with the following drawings, in which:

FIG. 1 illustrates a legend for FIGS. 2 through 8.

FIG. 2 illustrates a graphical representation of a Gas Scrubber [1] to adsorb/precipitate available Gas Flow into an aqueous phase in combination with an optional Salt Reactor [2] to convert any remaining CO_{X} and/or NO_{X} into a final metal salt, wherein a Separator [3} separates precipitated final metal salt(s) from the aqueous phase.

FIG. 3 illustrates a graphical representation of a Gas Scrubber [1] to adsorb/precipitate available CO_{X} and/or NOx into an aqueous phase in combination with an optional Salt Reactor [2] to convert the available CO_{X} and/or NO_{X} into a final metal salt, wherein a Separator [3] separates precipitated final metal salt(s) from the aqueous phase, wherein the aqueous phase is recycled back to the Gas Scrubber [1], wherein further adsorption/precipitation occurs in a Salt Reactor [2A] in combination with further separation in Separator [3A], and wherein the aqueous phase is recycled to the Gas Scrubber

for further adsorption/precipitation of available COX and/or NOX into aqueous phase.

FIG. 4 illustrates a graphical representation of a Gas Scrubber [1] to adsorb/precipitate available COX and/or NOX into an aqueous phase in combination with an optional Salt Reactor [2] to convert the available COX and/or NOX into a final metal salt, wherein a Separator [3] separates precipitated metal salt(s) from the aqueous phase, wherein a Greenhouse [4] converts the precipitated CO₃²⁻ back into CO₂ for conversion into O₂ with algae, wherein a Separator [5] separates final metal salt(s) from the wastewater, and wherein said algae is available for harvesting.

FIG. 5 illustrates a graphical representation of a Gas Scrubber [1] to adsorb/precipitate available CO_{X} and/or NO_{X} into an aqueous phase in combination with an optional Salt Reactor [2] to convert the available CO_{X} and/or NO_{X} into a final metal salt, wherein a Separator [3] separates precipitated final metal salt(s) from the aqueous phase, wherein a Greenhouse [4] converts the precipitated CO₃²⁻ back into CO₂ for conversion into O₂ with algae, wherein a Separator [5] separates precipitated final metal salt(s) from the wastewater, wherein an Facultative Bio-Reactor [6] converts NO₂²⁻ and NO₃²⁻ within the wastewater into N₂, wherein a Separator [7] separates the wastewater from the bio-solids of the Facultative Bio-Reactor [6], and wherein said algae is available for harvesting.

FIG. 6 illustrates a graphical representation of a Catalysis Unit [8] to convert at least a portion of any NO_{X} combustion gases into N₂, along with a downstream Gas Scrubber [1] to adsorb/precipitate available CO_{X} and/or NO_{X} into an aqueous phase, in combination with an optional Salt Reactor [2] to convert any remaining CO_{X} and/or NO_{X} into a final metal salt, wherein a Separator [3} separates precipitated final metal salt(s) from the water phase.

FIG. 7 illustrates a graphical representation of a Catalysis Unit [8] to convert at least a portion of any NO_{X} combustion gases into N₂, along with a downstream Gas Scrubber [1] to adsorb/precipitate available CO_{X} and/or NO_{X} into an aqueous phase, in combination with an optional Salt Reactor [2] to convert the available CO_{X} and/or NO_{X} into a final metal salt, wherein a Separator [3] separates precipitated final metal salt(s) from the aqueous phase, wherein the aqueous phase is recycled back to the Gas Scrubber [1], wherein further adsorption/precipitation occurs in a Salt Reactor [2A] in combination with further separation in Separator [3A], and wherein the aqueous phase is recycled to the Gas Scrubber [1] for further adsorption/precipitation of available CO_{X} and/or NO_{X} into aqueous phase.

FIG. 8 illustrates a graphical representation of a Catalysis Unit [8] to convert at least a portion of any NOX combustion gases into N₂, along with a downstream Gas Scrubber [1] to adsorb/precipitate available CO_{X} and/or NO_{X} into an aqueous phase, in combination with an optional Salt Reactor [2] to convert the available CO_{X} and/or NO_{X} into a final metal salt, wherein a Separator [3] separates precipitated metal salt(s) from the aqueous phase, wherein a Greenhouse [4] converts the precipitated CO₃²⁻ back into CO₂ for conversion into O₂ with algae, wherein a Separator [5] separates precipitated metal salt(s) from the wastewater, wherein an Facultative Bio-Reactor [6] converts NO₂²⁻ and NO₃²⁻ within the wastewater into N₂, wherein a Separator [7] separates the wastewater from the bio-solids of the Facultative Bio-Reactor [6], and wherein said algae is available for harvesting.

### DETAILED DESCRIPTION OF THE PREFERRED EMBODIMENTS

### Chemical Equilibria

Chemical Equilibria and/or reactions which comprise an aspect of the instant invention include but are not limited to:

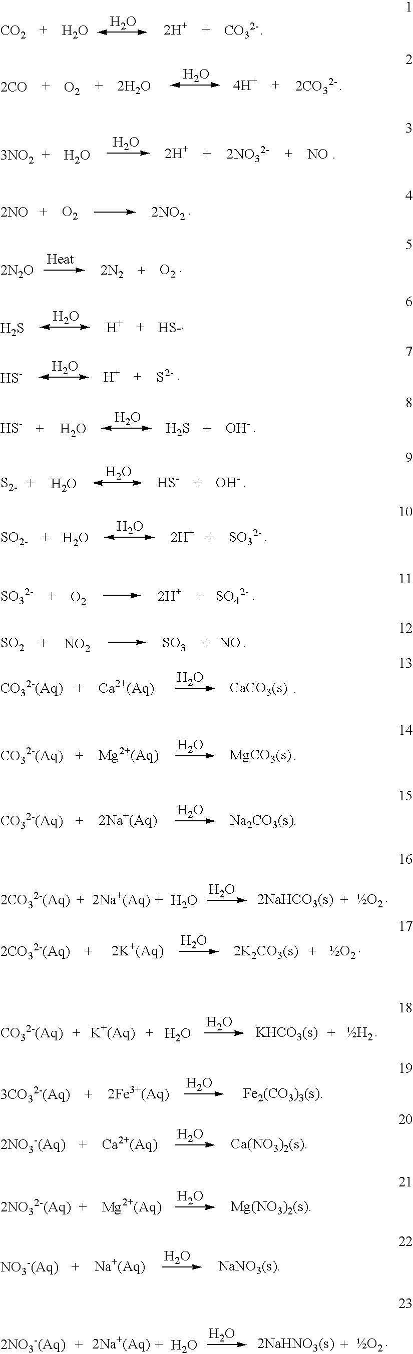

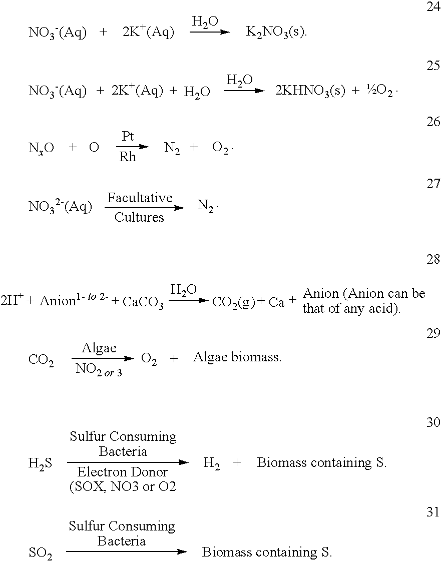

Timing of the instant invention is significant and meets a long felt need since global warming appears to be changing weather patterns around the Earth. Timing of the instant invention is significant and meets a long felt need since global warming is becoming a global political issue. Timing of the instant invention is significant and meets a long felt need since the products of hydrocarbon combustion are now affecting the health of humanity, as well as that of animals and plant life on Earth.

### Water Solubility Relationships

TABLE 1
Solubility in H₂O¹

| | (mg/100 ml H₂O)² | | | (mg/100 ml H₂O)² | |
|---|---|---|---|---|---|
| Gas | Cold H₂O | Hot H₂O | Gas | Cold H₂O | Hot H₂O |
| CO | 3.5 | 2.3 | H₂S | 437 cm³ | 186 cm³ |
| CO₂ | 0.348 | 0.097 | SO₂ | 22.8 | 0.58 |
| CO₃ | Soluble | Soluble | SO₃ | Decomposes | Decomposes |
| | | | | to H₂SO₄ | to H₂SO₄ |
| NO | 7.34 cm³ | 2.37 cm³ | SO₄²⁻ | Forms | Forms |
| | | | | H₂SO₄ | H₂SO₄ |
| | | | | or a | or a |
| | | | | metal salt | metal salt |
| N₂O | 130.0 | 56.7 | | | |
| NO₂ | Soluble | Decomposes | | | |
| NO₃ | Soluble | Soluble | | | |

| Metal | | | | |
|---|---|---|---|---|
| Cation | Cold H₂O | Hot H₂O | Cold H₂O | Hot H₂O |
| | Anion CO₃ (mg/100 ml H₂O)² | | Anion NO₃ (mg/100 ml H₂O)² | |
| Ca | 0.0015 | 0.0019 | 121.2 | 376.0 |
| Mg | 0.0106 | — | Soluble | Soluble |
| Na | 7.1000 | 45.5000 | 92.1 | 180.0 |
| K | 112.0000 | 156.0000 | 7.0 | 60.8 |
| Fe | II Insoluble | II Insoluble | II 83.5 | II 156.7 |
| | III Insoluble | III Insoluble | III Soluble | III Soluble |
| Mn | 0.0065 | Insoluble | 456.4 | Soluble |
| | Anion HSO₄ (mg/100 ml H₂O)² | | Anion SO₄ (mg/100 ml H₂O)² | |
| Ca | Soluble | Soluble | 0.209 | 0.161 |
| Mg | Soluble | Soluble | 20.0 | 73.8 |
| Na | Soluble | Soluble | 4.76 | 42.7 |
| K | 36.3 | 121.6 | 12.0 | 24.1 |

¹Reference CRC Handbook of Chemistry and Physics, 56'th Edition, CRC Press, 1975
²Unless otherwise noted.

The instant invention embodies the adsorption of at least one CO_{X} and/or NO_{X} molecule into a water, thereby creating an aqueous phase comprising the CO_{X} and/or NO_{X} molecule(s). The instant invention embodies the adsorption of at least one CO_{X} and/or NO_{X} molecule from a hydrocarbon combustion source into a water, thereby creating an aqueous phase comprising said CO_{X} and/or NO_{X} molecule(s). The instant invention further embodies the reaction of said aqueous phase CO_{X} and/or NO_{X} molecule(s) with a metal to further form an aqueous salt solution comprising the metal and a CO₃ and/or NO_{2 or 3} molecule(s). The instant invention further embodies the reaction of said aqueous phase molecule(s) with a Group IA and/or IIA metal to further form an aqueous salt solution comprising the Group IA and/or IIA metal and the CO₃ and/or NO_{2 or 3} molecule(s). The instant invention further still embodies the reaction of said aqueous salt solution with a metal to a point wherein said salt in said aqueous salt solution is at a concentration beyond its solubility point, such that the metal salt precipitates from said aqueous salt solution. The instant invention prefers the reaction of said aqueous salt solution with said Group IA and/or IIA metal to a point wherein said Group IA and/or IIA metal salt in said aqueous salt solution is at a concentration beyond its solubility point, such that said Group IA and/or IIA metal salt precipitates from said aqueous salt solution. It is most preferred that said metal salt comprise a Group IA metal for the formation of an insoluble salt comprising CO₃. It is most preferred that said metal salt comprise at least one of sodium or calcium for the formation of an insoluble salt comprising CO₃. It is most preferred that said metal salt comprise iron or magnesium for the formation of an insoluble salt comprising CO₃. It is most preferred that said Group IA and/or IIA metal salt comprise a Group IA metal for the formation of a insoluble salt comprising NO_{2or 3}. It is most preferred that said metal salt comprise potassium for the formation of an insoluble salt comprising NO_{2or 3}.

The instant invention embodies the addition of a dispersant to said aqueous salt solution comprising said Group IA and/or IIA metal salt precipitates. The instant invention embodies the addition of a dispersant to said aqueous salt solution comprising said Group IA and/or IIA metal salt precipitates such that the addition of said dispersant allows for further aqueous adsorption of CO_{X} and/or NO_{X} molecule(s) into the aqueous phase without significant agglomeration of said Group IA and/or IIA metal salt precipitates which would inhibit further aqueous phase adsorption of CO_{X} and/or NO_{X} molecule(s).

It is an embodiment that said metal be added to said aqueous solution in the form of a salt. It is preferred that said metal for the formation of an insoluble salt comprising CO₃ comprise at least one selected from the group consisting of: sodium sulfate (Na₂SO₄), sodium sulfate heptahydrate (Na₂SO₄·7H₂O), sodium sulfate decahydrate (Na₂SO₄·10H₂O), sodium bisulfate (NaHSO₄), sodium bisulfate monohydrate (NaHSO₄·H₂O), calcium sulfate (CaSO₄), calcium sulfate ½ hydrate (CaSO₄·½H₂O), calcium sulfate hydrate (CaSO₄·H₂O), calcium sulfate di-hydrate (CaSO₄·2H₂O), potassium sulfate (K₂SO₄), potassium bisulfate (KHSO₄), potassium sulfate ½ hydrate (KSO₄·½H₂O), potassium sulfate hydrate (KSO₄·H₂O), potassium sulfate di-hydrate (KSO₄·2H₂O), and any combination therein. It is preferred that said metal for the formation of an insoluble salt comprising NO_{X} comprise at least one selected from the group consisting of: potassium sulfate (KSO₄), potassium sulfate ½ hydrate (KSO₄·½H₂O), potassium sulfate hydrate (KSO₄·H₂O), potassium sulfate di-hydrate (KSO₄·2H₂O), and any combination therein. It is most preferred that said metal salt comprise a base so as to keep the metal solution alkaline. It is most preferred that said base comprise at least one of: sodium, potassium, calcium and magnesium. It is most preferred that said base comprise at least one of hydroxyl and oxygen anionic moiety.

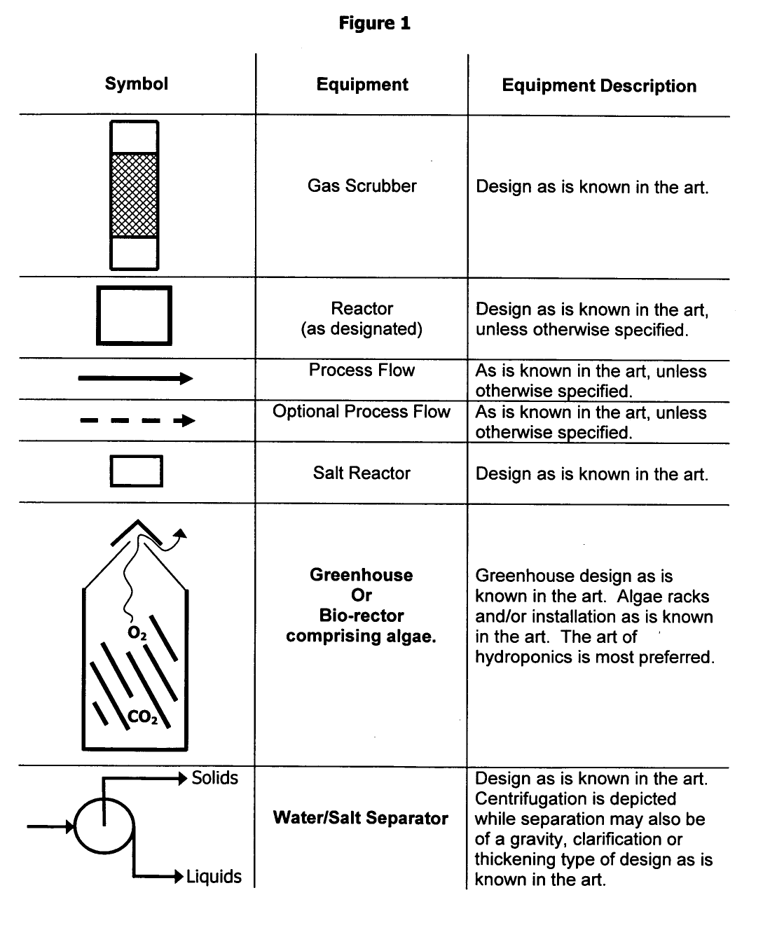

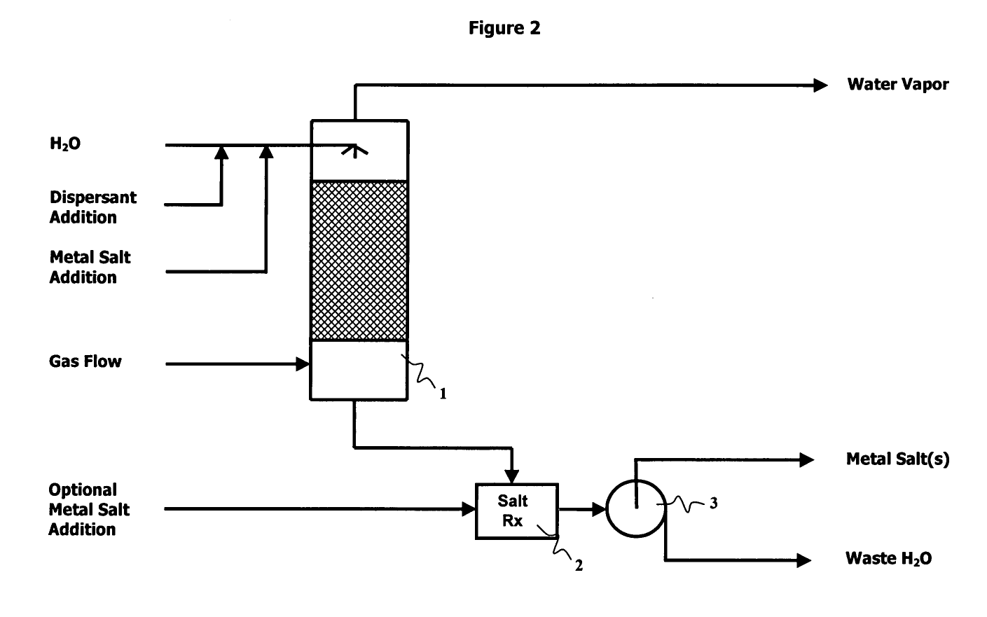

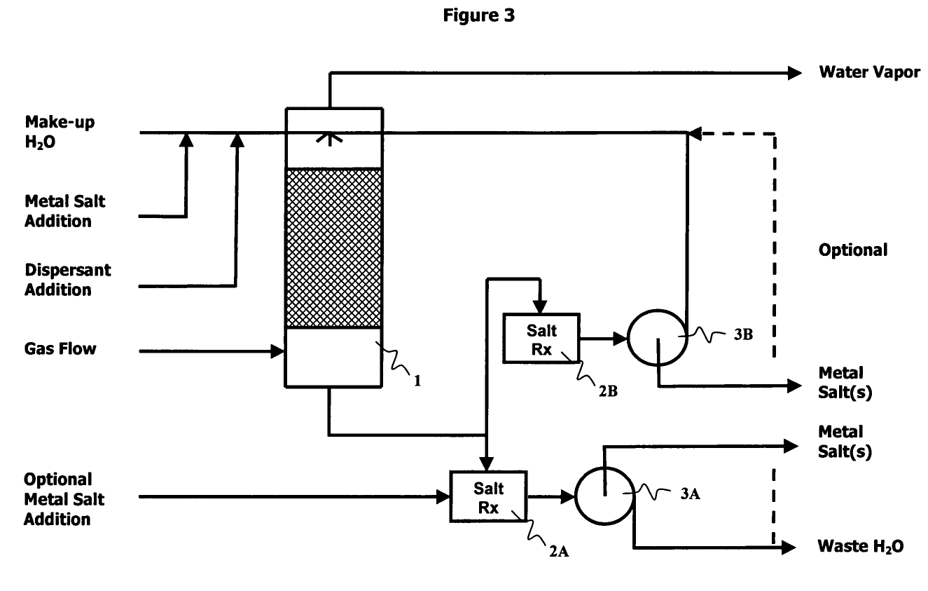

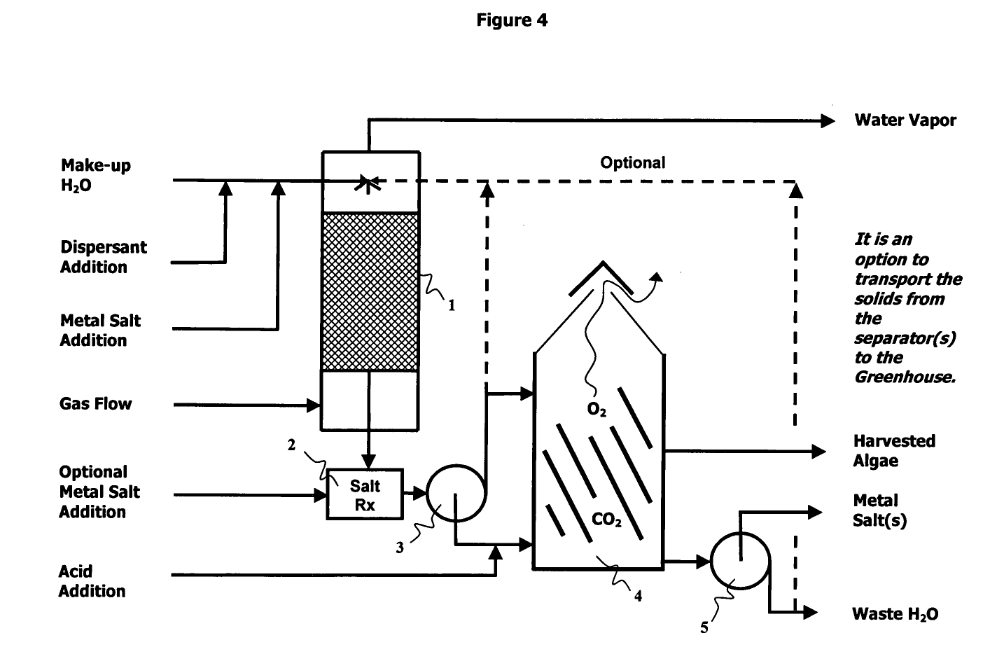

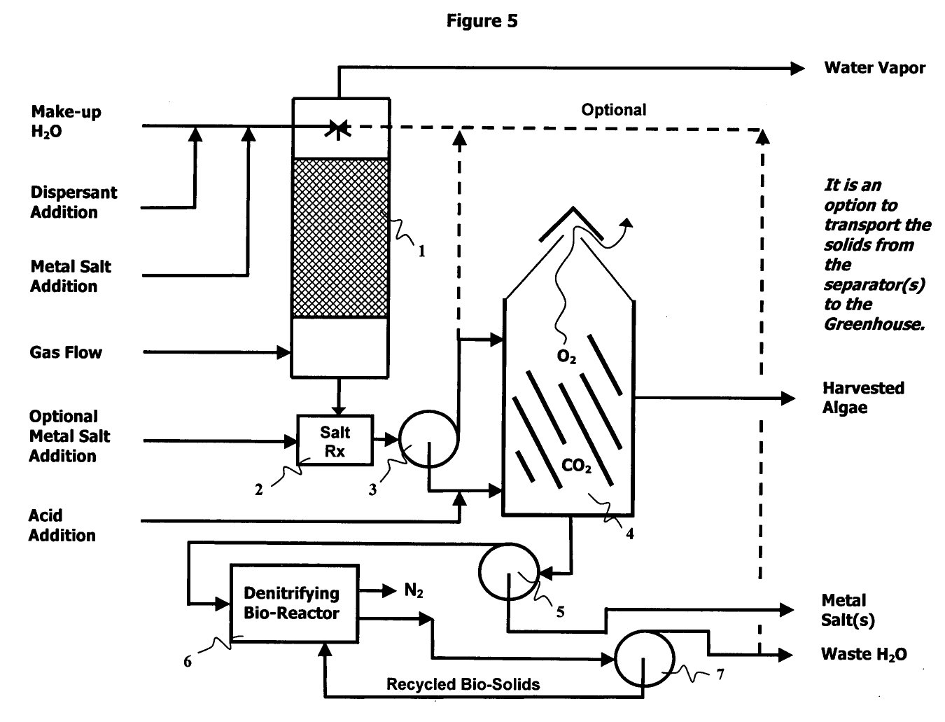

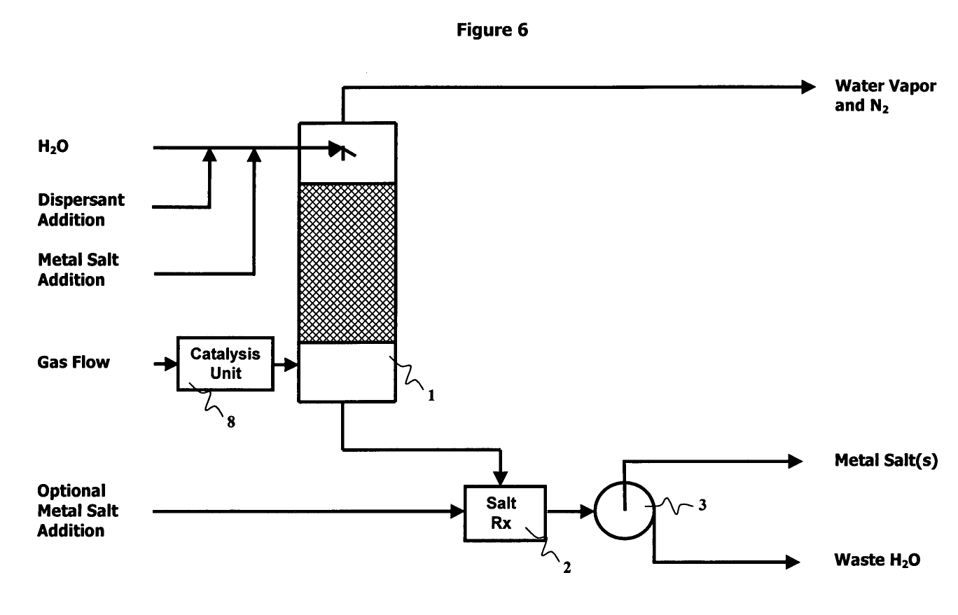

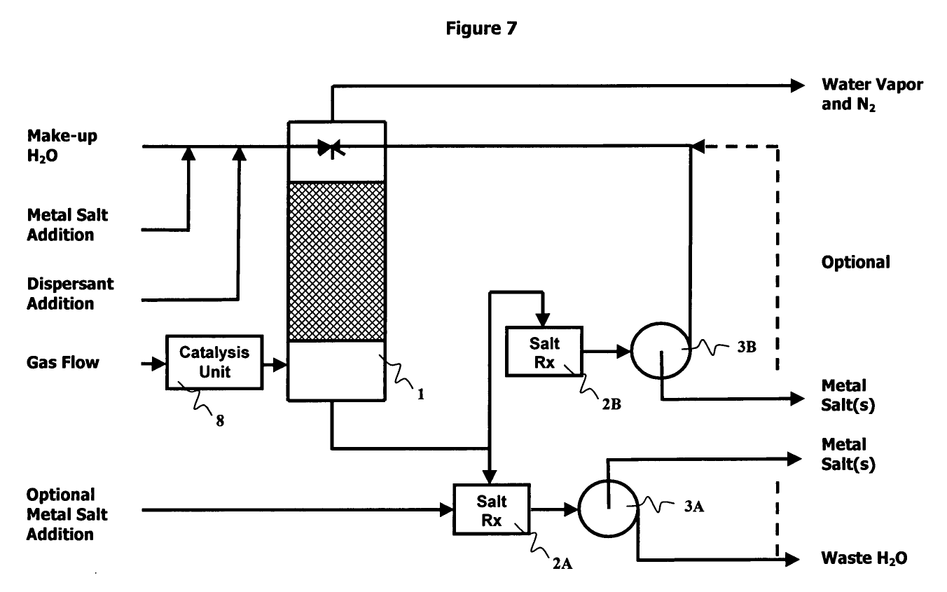

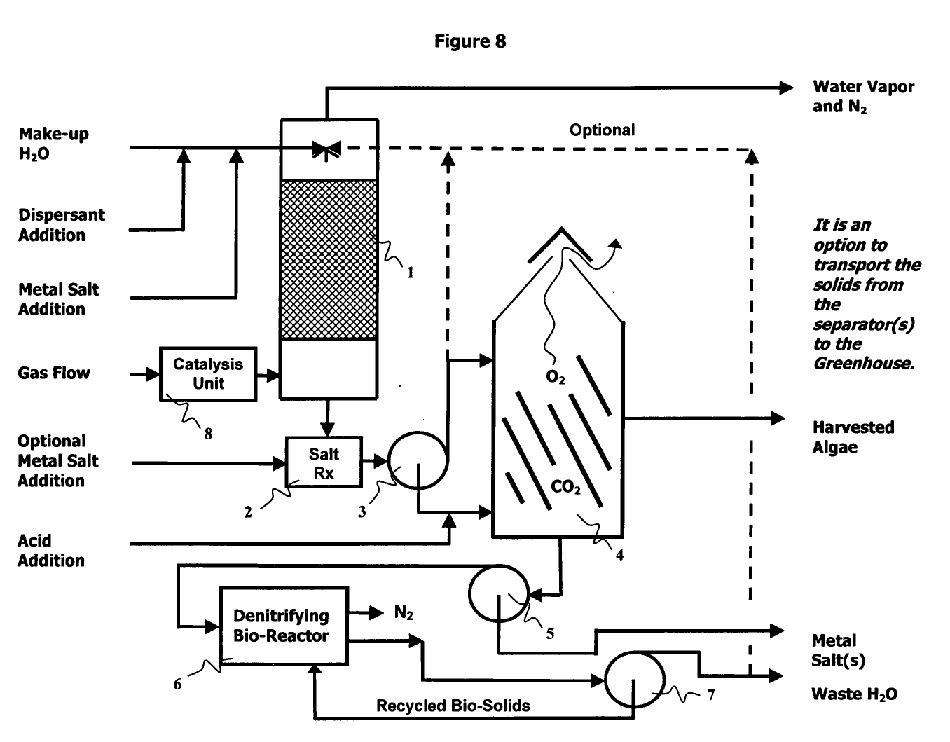

Scrubber—It is an embodiment to have a gas/water contact device to contact a gas or Gas Flow comprising at least one of CO_{X} and NO_{X} with H₂O in order to create a solution comprising the CO_{X} and/or NO_{X}. It is preferred that the Scrubber be of vertical type as is known in the art or as depicted in FIGS. 1, 2, 3, 4, 5, 6, 7 or 8. It is preferred that the water entering the Scrubber comprise a concentration of halogen acid or hypohalite so as to minimize the formation of insoluble metal CO_{X} and/or NO_{X} precipitate or of bacteria or of algae in the Scrubber. It is preferred that the water entering the Scrubber comprise a concentration of base so as to minimize the formation of bacteria or of algae in the Scrubber. It is preferred that the water entering the scrubber comprise a dispersant. It is preferred that the water entering the Scrubber comprise a metal salt so as to facilitate the formation of the corresponding metal CO₃ or NO₂ₒᵣ₃ salt in aqueous solution. It is most preferred that said halogen comprise chlorine. It is an embodiment that the Scrubber comprise metal construction. It is preferred that the Scrubber comprise a material which is corrosion resistant to halogen acids and/or bases. It is preferred that the Scrubber comprise a material which is capable of structural integrity at exhaust gas temperatures available from hydrocarbon combustion. It is preferred that the scrubber comprise at least one selected from the group consisting of: zirconium, hastelloy, titanium and inconnel, or metals of the like, polynylon, polyester (PET or PBT), polyetherimide, polyimide, polypropylene, or polymers of the like, and any combination therein. It is preferred that the Scrubber be downstream of a cooler which cools the combustion exhaust gases prior to entrance of the exhaust gases to the Scrubber. It is preferred that the Scrubber comprise a packing material so as to facilitate contact between the combustion exhaust gas and the water.

Further, to the extent that a 3-way catalytic converter is malfunctioning, e.g. not converting NOx to N₂, the aqueous phase in a scrubber can hold up to about; 120 to 370 gm of CaNO₃ per 100 cc of H₂O depending on temperature, or up to about 125 gm of MgNO₃ per 100 cc of H₂O depending on temperature, or up to about 92 to 180 gm of NaNO₃ per 100 cc of H₂O depending on temperature, or up to about 13 to 247 gm of KNO₃ per 100 cc of H₂O, depending on temperature; wherein, any concentration beyond the solubility limit will precipitate as the corresponding metal-NO₃ salt The adsorption of NO₃²⁻ in the aqueous phase and the corresponding metal-NO₃ salt has two advantages: first, NO_{X} emissions are at least partially controlled; and second, there is a ready measure of catalytic converter performance, e.g. conversion of NO_{X} to N₂, as any concentration of NO₂²⁻ or of NO₃²⁻ in the aqueous phase and/or salt in comparison to fuel use is a direct measure of catalytic converter NO_{X} performance. It is anticipated for catalytic converter maintenance to be more economical than the removal of NO₂²⁻ or of NO₃²⁻ from either the aqueous phase or the precipitate.

It is an embodiment to locate the Scrubber in the exhaust piping of a combustion device or engine, wherein the Scrubber has the means to adsorb at least a portion of the CO_{X} and/or NO_{X} produced in combustion. It is preferred that the Scrubber be sized so as to allow for at least a portion of the CO_{X} and/or NO_{X} produced in combustion to be adsorbed in the Scrubber aqueous phase. It is most preferred that the Scrubber be sized so as to allow for at about most to all of the CO_{X} and/or NO_{X} produced in combustion to be adsorbed in the Scrubber aqueous phase. It is preferred that the water for the Scrubber comprise an acid or a disinfecting moiety so as to control or minimize precipitate and/or biological growth in the Scrubber. It is preferred that the concentration of dispersant in the Scrubber be maintained so as to afford the Scrubber means to adsorb most to all of the CO_{X} and/or NO_{X} produced in combustion in the aqueous phase without agglomeration or plugging of the Scrubber by an unmanageable amount of precipitate. It is preferred that the Scrubber have an easy method of water removal and addition. It is most preferred that the water reservoir for the Scrubber be sized so as to allow for most to about all of the CO_{X} and/or NO_{X} produced in combustion to be adsorbed in the aqueous phase, e.g. scrubber water, in the form of a soluble salt or in the form of a precipitate. It is most preferred that the Scrubber and Scrubber water reservoir have a means of energy management so that the composition of the water therein can be managed in relation to water vapor formation and water freezing.

Salt Reactor—It is preferred that said Salt Reactor(s) comprise an agitation of a metal salt so as to provide mixing of a metal salt with the aqueous solution from said Scrubber. It is preferred that the Salt Reactor(s) comprise an auger-type of design to provide mixing of the metal salt with the aqueous solution from said Scrubber. It is most preferred that the Salt Reactor(s) comprise a grinding devise so as to prevent the agglomeration of metal CO₃ and/or NO₂ₒᵣ₃ precipitate which could either affect Salt Reactor mixing of said metal salt with said aqueous solution from said Scrubber or affect the flow of said aqueous solution from said Scrubber through said Salt Reactor(s).

It is preferred that the Salt Reactor(s) comprise a means for adding fresh metal salt to the Salt Reactor(s). It is preferred that the Salt Reactor(s) comprise a means for removing solids from the Salt Reactor(s). It is most preferred that the Salt Reactor(s) operate with an excess of metal salt over that anticipated in the formation of the corresponding metal-CO₃ and/or metal-NO₂ₒᵣ₃.

It is preferred to locate a Salt Reactor, wherein the exit water, aqueous phase, from said Scrubber enters the Salt Reactor, and wherein at least one of CO₃ and NO₂ₒᵣ₃ react with a metal salt in the Salt Reactor to form a metal-CO₃ and/or a metal-NO₂ₒᵣ₃ precipitate. It is preferred that the Salt Reactor be sized such that the Salt Reactor can convert at least a portion of the CO_{X} and/or NO_{X} in the aqueous phase from the Scrubber to a metal-CO₃ and/or a metal-NO₂ₒᵣ₃. It is most preferred that the Salt Reactor and the water reservoir be sized such that the Salt Reactor can convert most to all of the CO_{X} and/or NO_{X} in the aqueous phase from the Scrubber to a metal-CO₃ and/or a metal-NO₂ₒᵣ₃, wherein a portion of the CO_{X} in the aqueous phase precipitates as a metal-CO₃ and/or a portion of the NO₂ₒᵣ₃ precipitates as a metal-NO₂ₒᵣ₃ and wherein in aqueous solution is at least a portion of the remaining metal-CO₃ and/or metal-NO₂ₒᵣ₃. It is preferred that the Salt Reactor comprise an easy means of removing at least one of: any unused metal salt and any metal-CO₃ and/or a metal-NO₂ₒᵣ₃ formed. It is preferred that the Salt Reactor have an easy means of fresh salt addition.

It is preferred that the metal salt in said Salt Reactor comprise at least one metal cation. It is most preferred that said metal cation comprise at least one selected from the group consisting of: a metal, a Group IA or IIA metal, calcium, magnesium, sodium, potassium, a group VIII metal, iron, manganese, and any combination therein. It is preferred that the metal salt in said Salt Reactor comprise at least one anion selected from the group consisting of sulfate, sulfite, bisulfate, bisulfite, oxide, hydroxide, a halogen, chloride, bromide, nitrate, nitrite, hydride, and any combination therein. It is preferred that the metal salt in the salt reactor comprise an oxidizer capable of maintaining an alkaline pH in said Salt Reactor. It is most preferred that the pH in said Salt Reactor be between about 7.0 and about 10.0. It is an embodiment that the pH in said Salt Reactor be between about 6.0 and about 14.0.

Separator—It is an embodiment to locate a Separator downstream of said Scrubber and/or of said Salt Reactor so that the metal salts can be separated from aqueous solution. The Separator can be of any design as is known in the art. It is preferred that the separator be of gravity separation type of design, such as that which is known in a clarifier or in a thickener or in a belt dewatering press type of means. It is most preferred that the Separator be of centrifugation type of design.
Aqueous Recycle—It is an embodiment to recycle said aqueous salt solution from said Salt Reactor or from said Separator for adsorption of CO_{X} and/or NO_{X} in said Scrubber with said aqueous Scrubber aqueous phase. It is preferred to react said aqueous solution from said Scrubber with a metal salt solution in order to reduce the concentration of the metal(s) in said salt solution below their point of saturation in order to minimize fouling of said Scrubber with insoluble precipitate of said metal(s) CO₃ and/or NO₂ₒᵣ₃. It is most preferred to add a dispersant to an aqueous recycle so as to minimize fouling of said Scrubber with insoluble precipitate of said metal(s) CO₃ and/or NO₂ₒᵣ₃.
Dispersion Water Chemistry—A dispersant is preferably added to water to prevent scale. Dispersants are low molecular weight polymers, usually organic acids having a molecular weight of less than 25,000 and preferably less than 10,000. Dispersant chemistry is based upon carboxylic chemistry, as well as alkyl sulfate, alkyl sulfite and alkyl sulfide chemistry; it is the oxygen atom that creates the dispersion, wherein oxygen takes its form in the molecule as a carboxylic moiety and/or a sulfoxy moiety. Dispersants that can be used which contain the carboxyl moiety are, but are not limited to: acrylic polymers, acrylic acid, polymers of acrylic acid, methacrylic acid, maleic acid, fumaric acid, itaconic acid, crotonic acid, cinnamic acid, vinyl benzoic acid, any polymers of these acids and/or any combination therein. Dispersants that can be used contain the alkyl sulfoxy or allyl sulfoxy moieties include any alkyl or allyl compound, which is water soluble containing a moiety that is at least one of: SO, SO₂, SO₃, SO₄, and/or any combination therein. Due to the many ways in which an organic molecule can be designed to contain the carboxyl moiety and/or the sulfoxy moiety, it is an embodiment that any water soluble organic compound containing at least one of a carboxylic moiety and/or a sulfoxy moiety may be a dispersant in the instant invention. (This is with the knowledge that not all dispersants have equivalent dispersing properties.) Acrylic polymers exhibit very good dispersion properties, thereby limiting the deposition of water soluble salts and are most preferred embodiments as a dispersant. The limitation in the use of a dispersant is in the dispersants water solubility in combination with its carboxylic nature and/or sulfoxy nature.
Transportation—In transportation, the ability to reduce a gaseous CO_{X} to a solid salt for either conversion to O₂ or disposal purposes has significant value to humanity. As presented previously:

CₙH₂ₙ₊₂+(3/2n+½)O₂→nCO₂+(n+1)H₂O+Energy

More specifically, for gasoline (2, 2, 4 trimethyl pentane or n-Octane):

gasoline (Octane)+12½O₂→8CO₂+9H₂O+1,300 kcal

Therefore, an automobile obtaining 20 miles per gallon and a 15 gallon fuel tank produces about:

60 mph/20 mpg

[symbol]

(3 g)(5.8 lb./g)(454 gm/lb.)(/114)(M/gm Octane.)(8 M/M)(44 gm CO₂/M)≈24,400 gm CO₂/hr.≈400 gm CO₂/mile≈8,100 gm CO₂/gallon Octane, and
for that automobile a 15 gallon fuel tank [symbol] 122,000 gm CO₂/tank, which is only near 3 times the original fuel weight of near 39,500 gm.
A truck obtaining 4 mpg@ 60 mph and a 100 gallon fuel tank [symbol] 1,600 gm CO₂/mile and near 810,000 gm CO₂/tank of fuel, which is again about 3 times the original fuel weight of near 265,000 gm.

Converting CO₂ to CaCO₃ means for:

[symbol]

An automobile at 20 mpg and a 15 gallon fuel tank storing near 277,000 gm of CaCO₃ ((122,000)(100/44)) prior to refueling, which is about 6 times the original fuel weight, and

[symbol]

A truck at 4 mpg and a 100 gallon fuel tank storing near 1,840,000 gm of CaCO₃ (810,000 gm)(100/44) prior to refueling, which is again about 6 times the original fuel weight

Converting CO₂ to MgCO₃ means for:

[symbol]

An automobile at 20 mpg and a 15 gallon fuel tank storing near 240,000 gm of MgCO₃ ((122,000)(85/44)) prior to refueling, and

[symbol]

A truck at 4 mpg and a 100 gallon fuel tank storing near 1,565,000 gm of MgCO₃ (810,000 gm)(85/44) prior to refueling.

Converting CO₂ to NaHCO₃ means for:

[symbol]

An automobile at 20 mpg and a 15 gallon fuel tank storing near 190,000 gm of NaHCO₃ ((122,000)(68/44)) prior to refueling, and

[symbol]

A truck at 4 mpg and a 100 gallon fuel tank storing near 1,252,000 gm of NaHCO₃ (810,000 gm)(68/44) prior to refueling.

Converting CO₂ to KHCO₃ Means for:

[symbol]

An automobile at 20 mpg and a 15 gallon fuel tank storing near 233,000 gm of KHCO₃ ((122,000)(84/44)) prior to refueling, and

[symbol]

A truck at 4 mpg and a 100 gallon fuel tank storing near 1,546,000 gm of NaHCO₃ (810,000 gm)(84/44) prior to refueling.

It is preferred that the refueling station wherein a mode of transport obtains hydrocarbon, fossil, fuel have the capability of providing to said mode of transportation fresh water for said Scrubber. It is preferred that the refueling station wherein a mode of transport obtains hydrocarbon, fossil fuel have the capability of taking from the mode of transport any stored aqueous phase from said Scrubber. It is preferred that the refueling station wherein the mode of transport obtains hydrocarbon, fossil fuel have the capability of providing to said mode of transportation fresh metal salt. It is preferred that the refueling station wherein the mode of transport obtains hydrocarbon, fossil, fuel have the capability of taking from the mode of transport any unused metal salt and/or any metal-CO₃ and/or a metal-NO_{X} formed.

Catalysis—It is an embodiment to locate a metal catalyst in the exhaust of a hydrocarbon combustion engine or furnace prior to and/or after the Scrubber in order to minimize NO_{X} to the Scrubber and/or to the atmosphere. It is preferred that the metal(s) in said metal catalyst comprise at least one of platinum and rhodium

Metal Salt(s) Processing—It is an embodiment that the metals salt(s) comprise at least one selected from the group consisting of said: Scrubber, Salt Reactor, Separator, and any combination therein, be provided a means to an algae-type greenhouse or any bio-reactor of the like wherein the algae and/or plant growth therein is fed at least one of CO_{X} and/or NO₂ₒᵣ₃ as a food source. It is preferred that said solid phase from said Salt Reactor when located at the greenhouse be treated with an acid so as to release at least one of CO₂ and/or NO₂ₒᵣ₃ SO as to provide the CO₂ and/or NO₂ₒᵣ₃ as a food source for the plant growth in the greenhouse. It is preferred that said acid be a sulfoxy acid. It is most preferred that said acid be sulfuric acid

It is an embodiment that the solid phase from said Salt Reactor be used as a construction material. It is preferred that the solid phase from said Salt Reactor be used as a soil stabilizer. It is preferred that the solid phase from said Salt Reactor be used as a material in wallboard construction. It is preferred that the solid phase from said Salt Reactor be used as a material in marble manufacture.

It is preferred that the solid phase from said Salt Reactor be washed with water so as to reduce the concentration of NO₂ₒᵣ₃ in the solid phase.

It is most preferred that the solid phase from at least one selected from the group consisting of said: Scrubber, Salt Reactor, Separator, and any combination therein, be stored as a means of storing said CO_{X} and/or NO_{X} in a solid form.

It is most preferred that the solid phase from at least one selected from the group consisting of said: Scrubber, Salt Reactor, Separator, and any combination therein, be stored in the ocean or any body of water comprising an alkaline pH so as to maintain at least a portion of said CO_{X} and/or NO_{X} in a solid form.

Aqueous Phase Processing—It is an embodiment that the aqueous phase from at least one selected from the group consisting of said: Scrubber, Salt Reactor, Separator, and any combination therein, be provided the means of an algae-greenhouse or reactor of the like wherein algae and/or plant growth therein is fed CO₂ and/or NO₂ₒᵣ₃ as a food source.

It is an embodiment that the aqueous phase from at least one selected from the group consisting of said: Scrubber, Salt Reactor, Separator, and any combination therein, be provided the means of denitrification, as is known in the art, wherein facultative bacteria, as are known in the art, reduce the NO₂ₒᵣ₃ in the aqueous phase to N₂. It is preferred that said means of denitrification comprise a carbon source for growth of said facultative bacteria It is most preferred that the COD:N ratio within said denitrification means be between 6:1 and 3:1. It is an embodiment that the aqueous phase from said Salt Reactor be sent to an anaerobic biological means comprising (sulfur reducing bacteria) SRB bacteria, as are known in the art, wherein any sulfite, bi-sulfite, sulfate or bi-sulfate within the aqueous phase are reduced to sulfides by the SRB bacteria. In the operating scenario wherein anaerobic means are used to reduce any or either of said sulfite, bi-sulfite, sulfate or bi-sulfate, it is preferred that downstream of the SRB anaerobic means there be a facultative biological means comprising sulfur consuming bacteria, as are known in the art, to convert at least a portion of any H₂S, SO₂, and SO₃ to elemental sulfur. It is most preferred that said sulfur consuming bacteria comprise one of the species of the genus Thiobacilus, such as Thiobacillus denitrificans. It is most preferred that said sulfur consuming bacteria have a source of carbon.

It is most preferred that the aqueous phase from at least one selected from the group consisting of said: Scrubber, Salt Reactor, Separator, and any combination therein, be stored in the ocean or any body of water comprising an alkaine pH so as to maintain at least a portion of said CO_{X} and/or NO_{X} in a solid form.

It is preferred that the dissolved O₂ content within the aqueous phase of any facultative biological system be about 0.5 ppm O₂ or less. It is most preferred that the dissolved O₂ content within the aqueous phase of any facultative biological system be about 0.3 ppm O₂ or less.

It is most preferred that the carbon source for either denitrification or sulfide consuming bacteria be a form of waste water.

It is an embodiment to transport said precipitate and or said aqueous phase from at least one selected from the group consisting of said: Scrubber, Salt Reactor, Separator, and any combination therein, to at least one of: an algae greenhouse and a facultative biological reactor.

Sulfur Consuming Bacteria—It is an embodiment that an aqueous phase of the instant invention comprise bacteria (or bacterium) which metabolize or consume sulfur in their biomass. It is a preferred embodiment that an aqueous phase of the instant invention comprise at least one of: gram-negative bacteria from the beta or gamma subgroup of Proteobacteria, obligate autotrophs, Thioalkalovibrio, strain LMD 96.55, Thioalkalobacter, alkaliphilic heterotrophic bacteria, Pseudomonas strain ChG 3, Rhodococcus erythropolis, Rhodococcus rhodochrous, Rhodococcus sp., Nocardia erythropolis, Nocardia corrolina, other Nocardia sp., Pseudomonas putida, Pseudomonas oleovorans, Pseudomonas sp., Arthrobacter globiformis, Arthobacter Nocardia paraffinae, Arthrobacter paraffineus, Arthrobacter citreus, Arthrobacter luteus, other Arthrobacter sp., Mycobacterium vaccae JOB, sp. of Mycobacterium, Thiobacillus Shewanella sp., Micoccus cinneabareus, Micrococcus sp., Bacillus sulfasportare, bacillus Sp., Fungi, White wood rot fungi sp., Phanerochaete chrysospoium, Phanerochaete sordida, Trametes trogii, Tyromyces palustris, Streptomyces fradiae, Streptomyces globisporus, Streptomyces sp., Saccharomyces cerrevisiae, Candida Sp., Crptococcus albidus, Algae, sp. of the genus Thiobacillus, such as Thiobacillus denitrificans, and any combination therein.

It is most preferred that an aqueous phase of the instant invention comprise at least one of Thiobacillus and the strain Thiobacillus denitrificanus.

Denitrifying Bacteria—It is an embodiment that an aqueous phase of the instant invention perform facultative denitrification of NO₂²⁻ and NO₃²⁻. It is most preferred that said denitrification comprise at least one of: the genera Pseudomonas, Bacillus, and Achromobacter, as well as the facultative strains of Thiobacillus, such as Thiobacillus denitrificans.

### Apparatus for Manufacturing Plants and Process Flow Paths

It is a preferred embodiment that an apparatus comprise at least one source of Gas Flow and at least one Scrubber having a source of water flow form a manufacturing plant and/or process flow path, wherein said source(s) of Gas Flow is upstream of said Scrubber(s) and wherein the water in said Scrubber(s) comprises at least one of: a dispersant and a dispersant in combination with a metal salt. It is preferred that said metal salt comprise a Group IA or IIA metal salt. It is most preferred that at least one unit add said dispersant and/or said metal salt to said water in said Scrubber(s) and/or to the water prior to entering said Scrubber(s).

It is a preferred embodiment that an apparatus comprise at least one source of Gas Flow, at least one Scrubber having a source of water flow and at least one Separator form a manufacturing plant and/or process flow path, wherein said source(s) of Gas Flow is upstream of said Scrubber(s) and said Scrubber(s) is upstream of said Separator(s), wherein the water in said Scrubber(s) comprises at least one of: a dispersant and a dispersant in combination with a metal salt, and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one source of Gas Flow, at least one Scrubber having a source of water flow, at least one Salt Reactor and at least one Separator form a manufacturing plant and/or process flow path, wherein said source(s) of Gas Flow is upstream of said Scrubber(s), said Scrubber(s) is upstream of said Salt Reactor(s) and/or said Separator(s), wherein the water in said Scrubber(s) comprises at least one of a dispersant and a dispersant in combination with a metal salt, wherein said Salt Reactor(s) forms from the reaction of an aqueous solution with metal salt a metal-CO₃ salt, and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one source of Gas Flow, at least one Scrubber having a source of water flow and at least one Greenhouse and/or reactor form a manufacturing plant and/or process flow path, wherein said source(s) of Gas Flow is upstream of said Scrubber(s) and said Scrubber(s) is upstream of said Greenhouse(s) and/or reactor(s), wherein the water in said Scrubber(s) comprises at least one of: a dispersant and a dispersant in combination with a metal salt, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one source of Gas flow, at least one Scrubber having a source of water flow, at least one Salt Reactor and at least one Greenhouse and/or reactor form a manufacturing plant and/or process flow path, wherein said source(s) of Gas Flow is upstream of said Scrubber(s), said Scrubber(s) is upstream of said Salt Reactor(s) and/or said Greenhouse(s) and/or reactor(s), wherein the water in said Scrubber(s) comprises at least one of a dispersant and a dispersant in combination with a metal salt, wherein said Salt Reactor(s) forms from the reaction of an aqueous solution with metal salt a metal-CO₃ salt, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one source of Gas Flow, at least one Scrubber having a source of water flow and at least one Greenhouse and/or reactor form a manufacturing plant and/or process flow path, wherein said source(s) of Gas Flow is upstream of said Scrubber(s) and said Scrubber(s) is upstream of said Greenhouse(s) and/or reactor(s), wherein the water in said Scrubber(s) comprises at least one of a dispersant and a dispersant in combination with a metal salt, wherein said Greenhouse(s) and/or reactor(s) an acid converts metal-CO₃ from said Scrubber into a metal salt and CO₂ gas, and wherein said Greenhouse(s) and/or reactor(s) converts at least one selected from the list consisting of said CO₂ gas into O₂ plant growth. It is most preferred that said plant growth comprise algae. It is preferred that said metal salt comprise a Group IA or IIA metal salt. It is most preferred that said acid comprise sulfuric acid. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one source of Gas Flow, at least one Scrubber having a source of water flow, at least one Salt Reactor and at least one Greenhouse and/or reactor form a manufacturing plant and/or process flow path, wherein said Source(s) of CO_{X} is upstream of said Scrubber(s) and said Scrubber(s) is upstream of said Greenhouse(s) and/or reactor(s), wherein the water in said Scrubber(s) comprises at least one of a dispersant and a dispersant in combination with a metal salt, wherein said Salt Reactor(s) forms from the reaction of an aqueous solution with metal salt a metal-CO₃ salt, wherein said Greenhouse(s) and/or reactor(s) an acid converts metal-CO₃ from said Scrubber into a metal salt and CO₂ gas, and wherein said Greenhouse(s) and/or reactor(s) converts at least one selected from the list consisting of said CO₂ gas into O₂ plant growth. It is most preferred that said plant growth comprise algae. It is preferred that said metal salt comprise a Group IA or IIA metal salt. It is most preferred that said acid comprise sulfuric acid. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise least one Source of CO_{X} gas flow, at least one Scrubber having a source of water flow, at least one Separator, at least one Mode of Solids Transportation and at least Greenhouse and/or reactor form a manufacturing plant and/or process flow path, wherein said Source(s) of CO_{X} is upstream of said Scrubber(s), said Scrubber(s) is upstream of said Separator(s), said Mode of Solids Transport is upstream of said Greenhouse(s) and/or reactor(s), wherein the water in said Scrubber(s) comprises at least one of: a dispersant and a dispersant in combination with a metal salt, wherein said Mode(s) of Solids Transport transports at least one metal salt comprising a metal-CO₃ from said Separator(s) to said Greenhouse(s) and/or reactor(s), wherein an acid converts metal-CO₃ from said Scrubber(s) into a metal salt and CO₂ gas, and wherein said Greenhouse(s) and/or reactor(s) converts said CO₂ gas into O₂ plant growth. It is most preferred that said plant growth comprise algae. It is preferred that said metal salt comprise a Group IA or IIA metal salt. It is most preferred that said acid comprise sulfuric add. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) and/or said Separator(s) flow back to at least one of said Scrubber(s).

It is most preferred that at least one unit add said dispersant and/or said metal salt to said water in said Scrubber(s) and/or to the water prior to entering said Scrubber(s).

It is a preferred embodiment that an apparatus comprise least one Source of CO_{X} gas flow, at least one Scrubber having a source of water flow, at least one Salt Reactor, lat least one Separator, at least one Mode of Solids Transportation and at least Greenhouse and/or reactor form a manufacturing plant and/or process flow path, wherein said Source(s) of CO_{X} is upstream of said Scrubber(s), said Scrubber(s) is upstream of said Salt Reactors and/or said Separator(s) said Mode of Solids Transport is upstream of said Greenhouse(s) and/or reactor(s), wherein the water in said Scrubber(s) comprises at least one of a dispersant and a dispersant in combination with a metal salt, wherein said Salt Reactor(s) forms from the reaction of an aqueous solution with metal salt a metal-CO₃ salt, wherein said Mode(s) of Solids Transport transports at least one metal salt comprising a metal-CO₃ from said Separator(s) to said Greenhouse(s) and/or reactor(s), wherein an acid converts metal-CO₃ from said Scrubber(s) into a metal salt and CO₂ gas, and wherein said Greenhouse(s) and/or reactor(s) converts said CO₂ gas into O₂ plant growth. It is most preferred that said plant growth comprise algae. It is preferred that said metal salt comprise a Group IA or IIA metal salt. It is most preferred that said acid comprise sulfuric acid. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) and/or said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow and at least one Scrubber having a source of water flow form a manufacturing plant and/or process flow path, wherein said Combustion Source(s) is upstream of said Scrubber(s) and wherein the water in said Scrubber(s) comprises at least one of: a dispersant and a dispersant in combination with a metal salt. It is preferred that said metal salt comprise a Group IA or IIA metal salt. It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Catalysis Unit, and at least one Scrubber having a source of water flow form a manufacturing plant and/or process flow path, wherein said combustion source(s) is upstream of said Catalysis Unit(s), said Catalysis Unit(s) is upstream of said Scrubber(s), wherein the water in said Scrubber(s) comprises at least one of: a dispersant and a dispersant in combination with a metal salt and wherein said Catalysis Unit(s) comprise at least one of Platinum and Rhodium. It is preferred that said metal salt comprise a Group IA or IIA metal salt. It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Scrubber having a source of water flow and at least one Separator form a manufacturing plant and/or process flow path, wherein said combustion source(s) is upstream of said Scrubber(s) and said Scrubber(s) is upstream of said Separator(s), wherein the water in said Scrubber(s) comprises at least one of: a dispersant and a dispersant in combination with a metal salt, and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Catalysis Unit, at least one Scrubber having a source of water flow and at least one Separator form a manufacturing plant and/or process flow path, wherein said combustion source(s) is upstream of said Catalysis Unit(s), said Catalysis Unit(s) is upstream of said Scrubber(s) and said Scrubber(s) is upstream of said Separator(s), wherein said Catalysis Unit(s) comprise at least one of Platinum and Rhodium, wherein the water in said Scrubber(s) comprises at least one of: a dispersant and a dispersant in combination with a metal salt, and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Scrubber having a source of water flow, at least one Salt Reactor and at least one Separator form a manufacturing plant and/or process flow path, wherein said Combustion Source(s) is upstream of said Catalysis Unit(s), said Scrubber(s) is upstream of said Salt Reactor(s) and/or said Separator(s), wherein the water in said Scrubber(s) comprises at least one of: a dispersant and a dispersant in combination with a metal salt, wherein said Salt Reactor(s) forms from the reaction of an aqueous solution with metal salt a metal-CO₃ salt and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Catalysis Unit, at least one Scrubber having a source of water flow, at least one Salt Reactor and at least one Separator form a manufacturing plant and/or process flow path, wherein said Combustion Source(s) is upstream of said Catalysis Unit(s), said Catalysis Unit(s) are upstream of said Scrubber(s) and said Scrubber(s) is upstream of said Salt Reactor(s) and/or said Separator(s), wherein the water in said Scrubber(s) comprises at least one of: a dispersant and a dispersant in combination with a metal salt, wherein said Catalysis Unit(s) comprise at least one of Platinum and Rhodium, wherein said Salt Reactor(s) forms from the reaction of an aqueous solution with metal salt a metal-CO₃ salt and wherein the solid phase from said Separator(s) comprises a metal salt comprising at least one of CO₃, NO₂ and NO₃. It is preferred that said metal salt comprise a Group IA or IIA metal salt. It is most preferred that at least a portion of the aqueous phase from said Separator(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Scrubber having a source of water flow, at least one Separator and at least one Facultative Bio-Reactor form a manufacturing plant and/or process flow path, wherein said Combustion Source(s) is upstream of said Scrubber(s), said Scrubber(s) is upstream of said Separator(s) and said Separator(s) is upstream of said Facultative Bio-Reactor(s), wherein the water in said Scrubber(s) comprises at least one of a dispersant and a dispersant in combination with a metal salt, wherein the solid phase from said Separator(s) comprises a metal salt comprising at least one of CO₃, NO₂ and NO₃, and wherein said Facultative Bio-Reactor(s) converts at least a portion of the NO₂ and/or NO₃ in the aqueous phase from said Separator(s) into N₂. It is preferred that said metal salt comprise a Group IA or IIA metal salt. It is most preferred that at least a portion of the aqueous phase in said Facultative Bio-Reactor comprise at least one of Thiobacillus and Thiobacillus denitrificanus. It is most preferred that at least a portion of the aqueous phase from said Separator(s) and/or said Facultative Bio-Reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion source having a gas flow, at least one Catalysis Unit, cat least one Scrubber having a source of water flow, at least one Separator and at least one Facultative Bio-Reactor form a manufacturing plant and/or process flow path, wherein said Combustion Source(s) is upstream of said Catalysis Unit(s), said Catalysis Unit(s) is upstream of said Scrubber(s), said Scrubber(s) is upstream of said Separator(s) and said Separator(s) is upstream of said Facultative Bio-Reactor(s), wherein said Catalysis Units comprise at least one of Platinum and Rhodium, wherein the water in said Scrubber(s) comprises at least one of: a dispersant and a dispersant in combination with a metal salt, wherein the solid phase from said Separator(s) comprises a metal salt comprising at least one of CO₃, NO₂ and NO₃, and wherein said Facultative Bio-Reactor(s) converts at least a portion of the NO₂ and/or NO₃ in the aqueous phase from said Separator(s) into N₂. It is preferred that said metal salt comprise a Group IA or IIA metal salt. It is most preferred that at least a portion of the aqueous phase in said Facultative Bio-Reactor comprise at least one of Thiobacillus and Thiobacillus denitrificanus. It is most preferred that at least a portion of the aqueous phase from said Separator(s) and/or said Facultative Bio-Reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Scrubber having a source of water flow, at least one Salt Reactor and at least one Greenhouse and/or reactor form a manufacturing plant and/or process flow path, wherein said Combustion Source(s) is upstream of said Scrubber(s) and said Scrubber(s) is upstream of said Salt Reactor(s) and/or said Greenhouse(s) and/or reactor(s), wherein the water in said Scrubber(s) comprises at least one of: a dispersant and a dispersant in combination with a metal salt, wherein said Salt Reactor(s) forms from the reaction of an aqueous solution with metal salt a metal-CO₃ salt and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Catalysis Unit, at least one Scrubber having a source of water flow, at least one Salt Reactor and at least one Greenhouse and/or reactor form a manufacturing plant and/or process flow path, wherein said Combustion Source(s) is upstream of said Catalysis Units(s), said Catalysis Unit(s) is upstream of said Scrubber(s) and said Scrubber(s) is upstream of said Salt Reactor(s) and/or said Greenhouse(s) and/or reactor(s), wherein said Catalysis Units comprise at least one of Platinum and Rhodium, wherein the water in said Scrubber(s) comprises at least one of: a dispersant and a dispersant in combination with a metal salt, wherein said Salt Reactor(s) forms from the reaction of an aqueous solution with metal salt a metal-CO₃ salt and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) comprise at least one of Thiobacillus and Thiobacillus denitrificanus. It is most preferred that at least a portion of the aqueous phase from said Greenhouse(s) and/or reactor(s) flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Scrubber having a source of water flow, at least one Facultative Bio-Reactor and at least one Greenhouse and/or reactor form a manufacturing plant and/or process flow path, wherein said Combustion source(s) is upstream of said Scrubber(s), said Scrubber(s) is upstream of said Separator(s), said Separator(s) is upstream of said Facultative Bio-Reactor(s) and said Greenhouse(s) and/or reactor(s), wherein the water in said Scrubber(s) comprises at least one of: a dispersant and a dispersant in combination with a metal salt, wherein the solid phase from said Separator(s) comprises a metal salt comprising at least one of CO₃, NO₂ and NO₃, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N2, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) and/or said Facultative Bio-Reactor(s) comprise at least one of Thiobacillus and Thiobacillus denitrificanus. It is most preferred that at least a portion of the aqueous phase from at least one selected from the list consisting of: said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s).

It is a preferred embodiment that an apparatus comprise at least one Combustion Source having a gas flow, at least one Catalysis Unit, at least one Scrubber having a source of water flow, at least one Facultative Bio-Reactor and at least one Greenhouse and/or reactor form a manufacturing plant and/or process flow path, wherein said Combustion Source(s) is upstream of said Catalysis Unit(s), said Catalysis Unit(s) is upstream of said Scrubber(s), said Scrubber(s) is upstream of said Separator(s), said Separator(s) is upstream of said Facultative Bio-Reactor(s) and said Greenhouse(s) and/or reactor(s), wherein said Catalysis Units comprise at least one of Platinum and Rhodium, wherein the water in said Scrubber(s) comprises at least one of a dispersant and a dispersant in combination with a metal salt, wherein the solid phase from said Separator(s) comprises a metal salt comprising at least one of CO₃, NO₂ and NO₃, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N₂, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) and/or said Facultative Bio-Reactor(s) comprise at least one of Thiobacillus and Thiobacillus denitrificanus. It is most preferred that at least a portion of the aqueous phase from at least one selected from the list consisting of said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s).

It is a preferred embodiment that apparatus comprise at least one Combustion Source having a gas flow, at least one Scrubber having a source of water flow, at least one Separator, at least one Facultative Bio-Reactor and at least one Greenhouse and/or reactor form a manufacturing plant and/or process flow path, wherein said Combustion Source(s) is upstream of said Scrubber(s), said Scrubber(s) is upstream of said Separator(s), said Separator(s) is upstream of said Facultative Bio-Reactor(s) and said Greenhouse(s) and/or reactor(s), wherein the water in said Scrubber(s) comprises at least one of a dispersant and a dispersant in combination with a metal salt, wherein the solid phase from said Separator(s) comprises a metal salt comprising at least one selected from the list consisting of: CO₃, NO₂, NO₃ and any combination therein, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N₂, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) and/or said Facultative Bio-Reactor(s) comprise at least one of Thiobacillus and Thiobacillus denitrificanus. It is most preferred that at least a portion of the aqueous phase from at least one selected from the list consisting of: said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s). It is most preferred that said solid phase from said Separator(s) have a Mode of Transport to said Greenhouse(s) and/or reactor(s).

It is a preferred embodiment that an apparatus comprise at least one Combustion Source having a gas flow, at least one Catalysis Unit, at least one Scrubber having a source of water flow, at least one Separator, at least one Facultative Bio-Reactor and at least one Greenhouse and/or reactor form a manufacturing plant and/or process flow path, wherein said Combustion Source(s) is upstream of said Catalysis Unit(s), said Catalysis Unit(s) is upstream of said Scrubber(s), said Scrubber(s) is upstream of said Separator(s), said Separator(s) is upstream of said Facultative Bio-Reactor(s) and said Greenhouse(s) and/or reactor(s), wherein said Catalysis Units comprise at least one of Platinum and Rhodium, wherein the water in said Scrubber(s) comprises at least one of a dispersant and a dispersant in combination with a metal salt, wherein the solid phase from said Separator(s) comprises a metal salt comprising at least one selected from the list consisting of: CO₃, NO₂, NO₃ and any combination therein, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N₂, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) and/or said Facultative Bio-Reactor(s) comprise at least one of Thiobacillus and Thiobacillus denitrificanus. It is most preferred that at least a portion of the aqueous phase from at least one selected from the list consisting of: said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s). It is most preferred that said solid phase from said Separator(s) have a Mode of Transport to said Greenhouse(s) and/or reactor(s).

It is a preferred embodiment that an apparatus comprise at least one Combustion Source having a gas flow, at least one Scrubber having a source of water flow, at least one Salt Reactor, at least one Separator, at least one Facultative Bio-Reactor and at least one Greenhouse and/or reactor form a manufacturing plant and/or process flow path, wherein said Combustion Source(s) is upstream of said Scrubber(s), said Scrubber(s) is upstream of said Salt Reactor(s) and/or said Separator(s), said Salt Reactor(s) is upstream of said Separator(s), said Separator(s) is upstream of said Facultative Bio-Reactor(s) and said Greenhouse(s) and/or reactor(s), wherein the water in said Scrubber(s) comprises at least one of: a dispersant and a dispersant in combination with a metal salt, wherein said Salt Reactor(s) react a metal salt with the aqueous phase from said Scrubber(s) to form a metal salt comprising at least one selected from the list consisting of CO₃, NO₂, NO₃ and any combination therein, wherein the solid phase from said Separator(s) comprises a metal salt comprising at least one selected from the list consisting of CO₃, NO₂, NO₃ and any combination therein, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N₂, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse and/or said Facultative Bio-Reactor comprise at least one of Thiobacillus and Thiobacillus denitrificanus. It is most preferred that at least a portion of the aqueous phase from at least one selected from the list consisting of: said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s). It is most preferred that said solid phase from said Separator(s) have a Mode of Transport to said Greenhouse(s) and/or reactor(s).

It is a preferred embodiment that an apparatus comprise at least one Combustion Source having a gas flow, at least one Catalysis Unit, at least one Scrubber having a source of water flow, at least one Salt Reactor, at least one Separator, at least one Facultative Bio-Reactor and at least one Greenhouse and/or reactor form a manufacturing plant and/or process flow path, wherein said Combustion Source(s) is upstream of said Catalysis Unit(s), said Catalysis Unit(s) is upstream of said Scrubber(s), said Scrubber(s) is upstream of said Salt Reactor(s) and/or said Separator(s), said Salt Reactor(s) is upstream of said Separator(s), said Separator(s) is upstream of said Facultative Bio-Reactor(s) and said Greenhouse(s) and/or reactor(s), wherein said Catalysis Units comprise at least one of Platinum and Rhodium, wherein the water in said Scrubber(s) comprises at least one of a dispersant and a dispersant in combination with a metal salt, wherein said Salt Reactor(s) react a metal salt with the aqueous phase from said Scrubber(s) to form a metal salt comprising at least one selected from the list consisting of: CO₃, NO₂, NO₃ and any combination therein, wherein the solid phase from said Separator(s) comprises a metal salt comprising at least one selected from the list consisting of: CO₃, NO₂, NO₃ and any combination therein, wherein at least a portion of the aqueous phase from said Separator(s) flows to said Facultative Bio-Reactor(s), wherein said Facultative Bio-Reactor(s) converts at least a portion of the NO₂ and/or NO₃ in the aqueous phase from said Separator(s) into N₂, and wherein said Greenhouse(s) and/or reactor(s) converts CO₂ into O₂ and plant growth. It is most preferred that said plant growth comprise algae. It is preferred that said metal salt comprise a Group IA or IIA metal salt. It is most preferred that at least a portion of the aqueous phase in said Greenhouse(s) and/or reactor(s) and/or said Facultative Bio-Reactor(s) comprise at least one of Thiobacillus and Thiobacillus denitrificanus. It is most preferred that at least a portion of the aqueous phase from at least one selected from the list consisting of: said Separator(s), said Facultative Bio-Reactor(s), said Greenhouse(s) and/or reactor(s), and any combination therein, flow back to at least one of said Scrubber(s). It is most preferred that at least one unit add said dispersant and/or said metal salt to said water in said Scrubber(s) and/or to the water prior to entering said Scrubber(s). It is most preferred that said solid phase from said Separator(s) have a Mode of Transport to said Greenhouse(s) and/or reactor(s).

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description, it is to be realized that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention, which, as a matter of language, might be said to fall in between

1. A method of adsorbing into water CO_{X} and/or NO_{X} gas, said method comprising,
contacting the CO_{X} and/or NO_{X} gas with water, wherein
the water comprises a metal salt, such that
in the water is formed a final metal salt along with an aqueous phase comprising the metal salt, and wherein
the final metal salt comprises at least one selected from the list consisting of the: metal-CO₃, metal-NO₂, metal-NO₃, and any combination therein.

2. The method of claim 1, wherein at least one of:
a. said CO_{X} and/or NO_{X} gas is from a combustion source,
b. said contacting is performed in a gas scrubber,
c. said metal salt comprises a Group IA or IIA metal,
d. said metal salt comprises at least one selected from the list consisting of: potassium, sodium, magnesium, calcium, and any combination therein,
e. said metal salt comprises at least one selected from the list consisting of: oxide, hydroxide, sulfite, sulfate, and any combination therein.
f. said aqueous phase comprises at least one strain of a sulfur consuming bacteria,
g. said CO_{X} and/or NO_{X} gas is contacted with a metal catalyst comprising Platinum or Platinum with Rhodium, and
h. said CO_{X} and/or NO_{X} gas is cooled prior to contacting with water.

3. The method of claim 1, further comprising a dispersant in said aqueous phase.

4. The method of claim 3, wherein said dispersant comprises at least one of
a. carboxyl or sulfoxy moiety, and
b. at least one selected from the list consisting of: acrylic polymers, acrylic acid, polymers of acrylic acid, methacrylic acid, maleic acid, fumaric acid, itaconic acid, crotonic acid, cinnamic acid, vinyl benzoic acid, any polymers of these acids, and any combination therein.

5. The method of claim 1, further comprising reacting said aqueous phase with additional metal salt to form an additional amount of said final metal salt.

6. The method of claim 5, wherein at least one of:
a. said additional metal salt comprises a Group IA or IIA metal, and
b. said additional metal salt comprises at least one selected from the list consisting of: potassium, sodium, magnesium, calcium, and any combination therein.

7. The method of claim 1, further comprising at least partially separating said aqueous phase from said final metal salt.

8. The method of claim 5, further comprising at least partially separating said aqueous phase from said final metal salt.

9. The method of claim 7, comprising at least one of: centrifugation, clarification, thickening and pressing to perform said separating.

10. The method of claim 1, further comprising transferring said final metal salt to a greenhouse and/or reactor, wherein at least a portion of said final metal salt is reacted with an acid to form CO₂ gas, and wherein
plant life in the greenhouse and/or reactor converts at least a portion of the CO₂ gas into O₂ gas.

11. The method of claim 10, wherein at least one of:
a. said acid is sulfuric acid, and
b. said plant life comprises algae.

12. The method of claim 1, further comprising the flowing of said aqueous phase to a facultative biological reactor, wherein
said NO₂ or NO₃ in the aqueous phase is at least partially converted to N₂ gas.

13. The method of claim 12, further comprising at least one of:
a. to said aqueous phase in said facultative biological reactor is added at least one of: the genera Pseudomonas, Bacillus, and Achromobacter, facultative strains of Thiobacillus, and Thiobacillus denitrificanus.
b. a source of carbon is added to said facultative biological reactor such that the COD:N ratio of the aqueous phase in said denitrifying reactor is about 6:1 to 3:1, and
c. wastewater is added to said facultative biological reactor such that the COD:N ratio of the aqueous phase in said denitrifying reactor is about 6:1 to 3:1.

14. The method of claim 1, further comprising the addition to said aqueous phase of at least one of: gram-negative bacteria from the beta or gamma subgroup of Proteobacteria, obligate autotrophs, Thioalkalovibrio, strain LMD 96.55, Thioalkalobacter, alkaliphilic heterotrophic bacteria, Pseudomonas strain ChG 3, Rhodococcus erythropolis, Rhodococcus rhodochrous, Rhodococcus sp., Nocardia erythropolis, Nocardia corrolina, Nocardia sp., Pseudomonas putida, Pseudomonas oleovorans, Pseudomonas sp., Ardirobacter globiformis, Arthobacter Nocardia paraffinae, Arthrobacter paraffineus, Arthrobacter citreus, Artirobacter luteus, Arthrobacter sp., Mycobacterium vaccae JOB, Mycobacterium sp., Acinetobacter sp., Corynebacterium sp., Thiobacillus ferrooxidans, Thiobacillus intermedia, Thiobacillus Shewanella sp., Micrococcus cinneabareus, Micrococcus sp., Bacillus sulfasportare, bacillus sp., Fungi, White wood rot fungi sp., Phanerochaete chrysosporium, Phanerochaete sordida, Trametes trogii, Tyromyces palustris, Streptomyces fradiae, Streptomyces globisporus, Streptomyces sp., Saccharomyces cerrevisiae, Candida sp., Cryptococcus albidus, Algae, sp. of the genus Thiobacillus, such as Thiobacillus denitrificans, and any combination therein.

15. The method of claim 1, further comprising the using of said final metal salt(s) as at least one of a:
a. soil stabilizer.
b. building material, and
c. pH buffer.

16. The method of claim 1, further comprising transporting said aqueous phase to at least one of:
the ocean,
an alkaline water, and
underground.

17-40. (canceled)

41. The method of claim 7, further comprising transferring said final metal salt to a greenhouse and/or reactor, wherein at least a portion of said final metal salt is reacted with an acid to form CO₂ gas, and wherein plant life in the greenhouse and/or reactor converts at least a portion of the CO₂ gas into O₂gas.

42. The method of claim 8, comprising at least one of: centrifugation, clarification, thickening and pressing to perform said separating.

43. The method of claim 8, further comprising transferring said final metal salt to a greenhouse and/or reactor, wherein at least a portion of said final metal salt is reacted with an acid to form CO₂ gas, and wherein
plant life in the greenhouse and/or reactor converts at least a portion of the CO₂ gas into O₂ gas.

44. The method of claim 10, further comprising the flowing of said aqueous phase to a facultative biological reactor, wherein
said NO₂ or NO₃ in the aqueous phase is at least partially converted to N₂ gas.
